(19) United States
(12) Patent Application Publication
(10) Pub. No.: US 2016/0288402 A1
(43) Pub. Date: Oct. 6, 2016

(54) METHOD AND FOLDING SLIDE DEVICE FOR FOLDING A BORDER OF A DECORATIVE LAYER, FOLDING DEVICE AND USE OF INDUCTION RECEIVER

(71) Applicant: KIEFEL GmbH, Freilassing (DE)

(72) Inventors: Rupert GSCHWENDTNER, Bad Reichenhall (DE); Andreas DANDL, Laufen (DE)

(21) Appl. No.: 15/090,162

(22) Filed: Apr. 4, 2016

(30) Foreign Application Priority Data
Apr. 3, 2015 (DE) 10 2015 004 493.1
Mar. 24, 2016 (DE) 10 2016 003 491.2

(51) Int. Cl. B29C 53/84; C09J 11/00; B29C 65/24; B29C 65/48; B29C 65/32; B29C 53/04

(52) U.S. Cl. CPC B29C 53/84; B29C 65/32; B29C 53/04; B29C 65/242; B29C 65/4815; C09J 11/00

(57) ABSTRACT

In order to simplify a folding process and render it more precise the invention suggests a method for folding a border of a decorative layer about an edge of a carrier part, in which the border is at least partially folded about this edge via a folding slide, and in which a fixing means in the form of an adhesive that can be activated is used to fix the border of the decorative layer in the folded state at a carrier part, with the method being characterized in that an induction source is used for activating the adhesive, which generates electromagnetic alternating fields causing eddies in an induction receiver which are converted into thermal energy.

### CROSS-REFERENCE TO RELATED APPLICATIONS

This application is related to and claims the benefit of German Patent Application No. DE 10 2015 004 493.1, filed on Apr. 3, 2015, and German Patent Application No. DE 10 2016 003 491.2, filed on Mar. 24, 2016, the contents of which are herein incorporated by reference in their entirety.

### TECHNICAL FIELD

The disclosure relates to a method for folding a border of a decorative layer about an edge of a carrier part, in which the border is initially folded via a folding slide at least partially about said edge, and in which a means of fixing is used in the form of an adhesive that can be activated in order to fix the border of the decorative layer in the folded state at the carrier part.

The disclosure also relates to a folding slide device for folding a border of a decorative layer about an edge of a carrier part with a spatially displaceable folding slide and with a heating device for heating the border of a decorative layer or an adhesive arranged at the border of the decorative layer.

The disclosure further relates to a folding device for folding a border of a decorative layer about an edge of a carrier part, with an electromechanically driven folding slide being provided for the folding process and the folding device being embodied to use a fixing means in the form of an adhesive in order to fix the border of the decorative layer in the folded state in a glue joint.

The disclosure further relates to the use of an induction receiver.

### BACKGROUND

Generic methods for folding a border of a decorative layer about an edge of a carrier part, respective folding devices for implementing the method, as well as folding slides used for this purpose are known.

In general, here components are used which may be used in the interior of land vehicles, watercrafts, and aircrafts, particularly however parts for the interior of conventional passenger vehicles. For purely exemplary purposes, here paneling shall be mentioned in the area of doors, dashboard displays, glove compartments, and center consoles. Respective parts are generally produced in a method in which a preferably flexible material layer, comprising a top and a bottom, is laminated on a preferably inherently stable carrier with a preferably three-dimensional surface contour.

In order to produce carrier parts with such a flexible decorative layer laminated thereon it is distinguished primarily between the so-called vacuum lamination (also called film lamination) and so-called pressure lamination.

In vacuum lamination generally plastic films are laminated as flexible material layers on the carrier parts by way of applying a vacuum. An adhesive is applied on the carrier and/or the flexible material layer, serving to connect the carrier and the flexible material layer. The material layer itself usually shows a decorative element, with leather-like grains being very popular.

The pressure lamination is generally used when flexible material layers are processed, which either cannot be subjected to a vacuum, such as textile materials for example, or which are not elastic or elastic only to a limited extent, such as leather or synthetic leather. Here, the carrier and the flexible material layer, inserted in the tool, are compressed and/or bonded otherwise in a predetermined pressure gap. In this method too, the connection of the elements is yielded by an adhesive applied on the carrier and/or the flexible material layer.

Frequently an adhesive is used for the connection of the two elements that can be thermally activated, which adhesive had been applied in advance to one or both elements. This adhesive must be activated prior or during the lamination process. The thermally activated adhesive may for example be a hot glue, also called hotmelt, but other thermally activated adhesives may be used as well, for example dispersed polyurethanes.

This may occur by heating the lamination tool and/or its half molds, so that the adhesive is activated by the heated mold in the glue joint between the carrier part and the flexible decorative layer by the carrier part and the flexible decorative layer contacting the heated mold. Here, the heating process occurs via a simultaneous heating of the carrier part and the flexible decorative layer. Alternatively it is known to heat the adhesive layer prior to combining the carrier part and the flexible decorative layer, for example by hot air or infrared radiation.

A generic method is known for example from WO 2015/018391 A1.

### SUMMARY

The disclosure provides an alternative or improvement compared to conventional methods and devices for folding a border of a decorative layer and use of induction receiver.

The disclosure provides a method for folding a border of a decorative layer about an edge of a carrier part, in which the border is at least partially folded about this edge via a folding slide, and in which a fixing means in the form of an adhesive that can be activated is used in order to fix the border of the decorative layer in the folded state at the carrier part, with an induction source being used to activate the adhesive, which generates electromagnetic alternating fields causing eddies to form in an induction receiver which are converted into thermal energy.

With the use of such induction sources in the present case not only hot air for heating the ambient air can be waived, but additionally the frequently expensive heating ducts for guiding hot air to the area to be heated can be waived as well.

Rather, in the present case the required thermal energy is initiated via an electromagnetic alternating field, which also results in shortened processing cycles.

With regards to terminology, the following is explained:

The “decorative layer” may comprise primarily film, cloth, webs, leather, synthetic leather, fir, and the like.

The “folding” shall primarily occur by a folding motion by 90° or by 180°, with other values perhaps also being relevant, primarily values greater than 90°, though.

The “carrier part” may be of an arbitrary nature. In particular, it represents a part of the interior paneling of a motor vehicle, such as an aircraft or a passenger vehicle or a truck.

The “folding slide” is very important in the present disclosure. It characterizes a type of folding device, in which the folding is not generated completely by impression into a tool, but in which individual discrete elements, namely folding slides, engage the border of the decorative layer to be folded and then fold the border of the decorative layer about the edge of the carrier part by a multidimensional motion and compress it there for the purpose of fixation. In the standard case, a folding slide is supported such that it shows at least two different axes of motion. This frequently represents a vertical stroke on the one side, on the other side a horizontally projecting motion, whereby, in practice other alignments are possible as well, however the motions are most easily calculated if at least two degrees of freedom differ from each other by 90°, for example.

The “fixation means” may primarily represent an adhesive. Within the group of adhesives, primarily thermally activated adhesives shall be considered, for example dispersed polyurethanes or hotmelts, with hotmelts in professional terminology frequently being called thermal fusion adhesive, hotmelt adhesive, hot glue, or hot-setting adhesive. Hot glues are usually free from solvents and form more or less solid products at room temperature, which are activated in the hot state and can be applied onto the adhesive area or may already be present thereon and upon cooling they form a bond.

In particular, various basic polymers are possible here, such as polyamides, polyethylenes, amorphous polyalpha-olefines, ethylene vinyl acetate—copolymers, polyester-elastomers, polyurethane-elastomers, copolyamide-elastomers, or vinyl acetate-copolymers, or resins or waxes, where often stabilizers or nucleating agents can be added.

In particular in connection with the execution of the method according to the disclosure, the disclosure provides a folding slide device for folding a border of a decorative layer about an edge of a carrier part with a spatially displaceable folding slide and with a heating device for heating the edge of the carrier part, the border of the decorative layer, or an adhesive arranged at the edge or the border, with the folding slide comprising an induction sources for generating an electromagnetic alternating field.

Such folding slide devices show a very simple design, so that the construction of a folding device is generally simplified in a beneficial fashion.

If the folding slide comprises an induction source in the sense of the disclosure, here other equipment for heating the adhesive or an appropriately heatable material can be waived, preferably entirely, with regards to the decorative layer and/or a carrier part.

Further, a folding slide designed in this fashion can easily be retrofitted in existing folding slide devices and/or folding devices.

It is understood that the present induction source can be located at most different positions of a folding device, as long as it can interact with an induction receiver in the sense of the disclosure.

The folding slide device can be designed in an even more space-saving fashion when the induction source is arranged at the side of the folding slide facing the decorative layer, preferably at least partially inside the folding slide. In particular by the arrangement of the induction source in the area of the side facing the decorative layer only a narrow distance must be bridged between the induction source and the induction receiver.

It is beneficial if the electromagnetic alternating field is generated via the folding slide, because the folding slide can be brought all the way up to the immediate proximity of the induction receiver.

The present method can be further simplified if the adhesive that can be activated is inductively heated, by the induction receivers included in the adhesive being heated via the electromagnetic alternating field emitted by the induction source. This way it is ensured that only those areas at the decorative layer and/or at the carrier part are heated which are mandatorily required for any bonding of the decorative layer and the carrier part. Any ambient areas are therefore subjected to less thermal stress or ideally none at all.

To this regard, in the present case an adhesive is used, which is embodied as an induction receiver and preferably shows primarily ferromagnetic particles.

Cumulatively or alternatively it is advantageous for the folding slide to comprise at least partially decorative layer—contact areas of the folding slide, particularly embodied as induction receivers, inductively heated by the electromagnetic alternating fields emitted by the induction source and before, during, and/or thereafter at least partially being made to contact the border of the decorative layer to be heated. This way, for example any adhesive provided at the decorative layer can be heated additionally or exclusively.

Accordingly it is also advantageous with regards of design when an inductively adjustable contact area is embodied as the induction receiver at the folding slide.

Cumulatively or alternatively an induction receiver can also be arranged at the decorative layer and/or the carrier part. A respective induction receiver may be embodied at the border of the decorative layer and/or at the edge of the carrier part, for example as a plurality of metallic threads inserted in a cloth, or as metallic inserts in a carrier part, or the like. To this regard, the induction receiver would then represent a component of the decorative layer and/or the carrier part.

The folding slide, particularly the induction source installed at the folding slide, and/or the decorative layer—contact area realized at the folding slide, can be protected from overheating in a particularly dependable fashion when the induction source is cooled by liquids. This also applies for electric contact elements for conducting electric energy to the folding slide.

To this regard it is advantageous when a cooling fluid flows through the folding slide. In addition to protection from overheating, a processing cycle running at the folding device can be further shortened when cooling fluid flows through the folding slide.

This way, the adhesive cannot only be heated via the folding slide, but furthermore it can subsequently be cooled again via said folding slide.

This way, with regards to the folding process both a heating device as well as a cooling device can be provided at an appropriately equipped folding device via a single functional part, namely via the folding slide.

The disclosure provides a folding device for folding a border of a decorative layer about an edge of a carrier part, with an electromechanically driven folding slide being provided for the folding process and the folding device being implemented in order to use a fixing means in the form of an adhesive to fix the border of the decorative layer in a glue joint in a folded state, and with the folding device showing an electromagnetic induction source and being implemented to switch on and off the induction source for the direct or indirect heating or actiSLIDEing of the adhesive. By such an induction source that can be activated the folding device can be simply equipped with regards to the design of the heating device.

Furthermore, by the use of such an electromagnetic induction source additionally the energy consumption can be considerably reduced so that particularly the method described here can be implemented in an energy-efficient fashion.

The disclosure provides the use of an induction receiver of an adhesive for heating said adhesive provided at a decorative layer for covering a carrier part and/or at a carrier element for supporting a decorative layer.

Here the induction receiver is preferably substituted in the adhesive present and/or perhaps even embodied by said adhesive.

The disclosure also provides the use of a decorative layer for covering a carrier part and/or a carrier part for carrying the decorative layer and/or an induction receiver arranged at a folding slide for heating the adhesive to adhere a border of the decorative layer to the edge of the carrier part.

By such an induction receiver the areas to be heated can be manipulated in a more targeted fashion, resulting in ambient areas which shall not be heated to be thermally stressed to a negligibly low extent or not at all.

Here, the induction receiver may be arranged at and/or in the decorative layer or at and/or in the carrier part.

Or it is arranged directly in the folding slide.

Combinations thereof are also possible.

Alternatively, the adhesive may also be formulated depending on the application by a material incorporating the decorative layer and/or the carrier part.

For example, ferromagnetic particles are provided in the area of the border of the decorative layer and/or the edge of the carrier part so that a respectively modified border and/or a respectively modified edge are embodied at least sectionally as the induction receiver.

A respective induction receiver may for example be embodied here as metallic threads inserted in a cloth or the like or as metallic inserts in a carrier part or the like. To this regards, the induction receiver would then be a part of the decorative layer and/or the carrier part.

Here it shall be mentioned that the features of the patent application WO 2015/018391 A1 mentioned at the outset shall be included entirely by way of reference.

### BRIEF DESCRIPTION OF THE DRAWINGS

Additionally, further features, effects, and advantages of the present disclosure are explained based on the attached drawing and the following description, in which as an example two variants of folding slide devices are shown and described, displaying differently designed folding slides comprising induction sources.

Components, even those of different exemplary embodiments, which are consistent in the individual figures, at least essentially, with regards to their function may here be marked with the same reference character, not requiring that the components are marked and explained in all figures.

In the drawings:

FIG. 1 schematically an initial position of a folding slide device in a side view comprising a folding slide equipped with an induction source;

FIG. 2 schematically another side view of the folding slider of FIG. 1, in the meantime displaced into a horizontal interim position;

FIG. 3 schematically another side view of the folding slide of FIGS. 1 and 2, additionally displaced vertically into a compression position;

FIG. 4 schematically the folding slide with a switched-on induction source shown in FIGS. 1 to 3 and the induction receiver substituted in an adhesive;

FIG. 5 schematically an alternative folding slide with a switched-on induction source and with a decorative layer—contact area representing the induction receiver; and

FIG. 6 schematically another side view of the folding slide of FIGS. 1 to 4 or alternatively of

FIG. 5, held in the compressed position, during an active cooling phase of the induction source via cooling water.

### DETAILED DESCRIPTION OF THE DRAWINGS

The folding slide device 1 shown in FIGS. 1 to 6 of a folding device 2, not shown in greater detail here, is shown and described in the following essentially only with regards to a first folding slide 3 (variant A) and another alternative folding slide 4 (variant B, FIG. 5).

The folding device 2, the folding slide device 1, and consequently also the folding slides 3 and 4 are provided to fold the border 5 of a decorative layer 6 about an edge 7 of a carrier part 8, with at least the border 5 of the decorative layer 6 being effectively connected permanently to the carrier part 8 and/or to the edge 7 of the carrier part 8.

According to the exemplary embodiments shown in FIGS. 1 to 6 the border 5 and the edge 7 are connected in a material-to-material connection via an additional fixing means 9 already applied at the carrier part 8.

Here, a thermally activated adhesive 10 is selected as the fixing means 9, which is applied as a strip (not separately marked) along the edge 7 on the carrier part 8.

The folding slide 3 shows a L-shaped basic body 15, which is supported at the folding device 2 in a linearly mobile fashion at least in two directions of motion 16 and 17, different from each other.

In this exemplary embodiment the folding slide 3 is displaceable back and forth namely on the one hand in horizontal directions 18A and 18B and on the other hand in the vertical directions 19 (only indicated and marked as an example) displaceable upwards and downwards. This way the folding slide 3 shows at least two levels of freedom, by which it can be spatially moved.

If necessary, the folding slide 3 may also show additional levels of freedom, for example it may additionally be supported rotationally about an axis of rotation (not shown) when its bearing at the folding slide device 1 is appropriately designed.

The folding slide 3 shows here preferably an electromechanically operating drive (not shown).

In any case, via the folding slide 3 the border 5 of the decorative layer 6 can be folded about the edge 7 of the carrier part 8 and here be stressed such that the edge 7 is encompassed by the decorative layer 6 and the decorative layer 6 therefore is fastened securely with permanent stress at the carrier part 8.

For this purpose, the folding slide 3 comprises a folding nose 20 by which it cooperates with the decorative layer 6.

The folding slide 3 comprises particularly a compression area 21 by which it additionally presses the folded border 5 of the decorative layer 6 temporarily to the carrier part 8 for generating a material-to-material connection.

The compression area 21 is located at the folding nose 20.

Further, an induction source 22 is arranged at the folding nose 20, which is here realized in the form of at least one electric coil element 23 (see particularly FIGS. 1, 4, and 5).

The induction source 22 is here inserted in the folding slide 3, thus arranged within the folding slide 3.

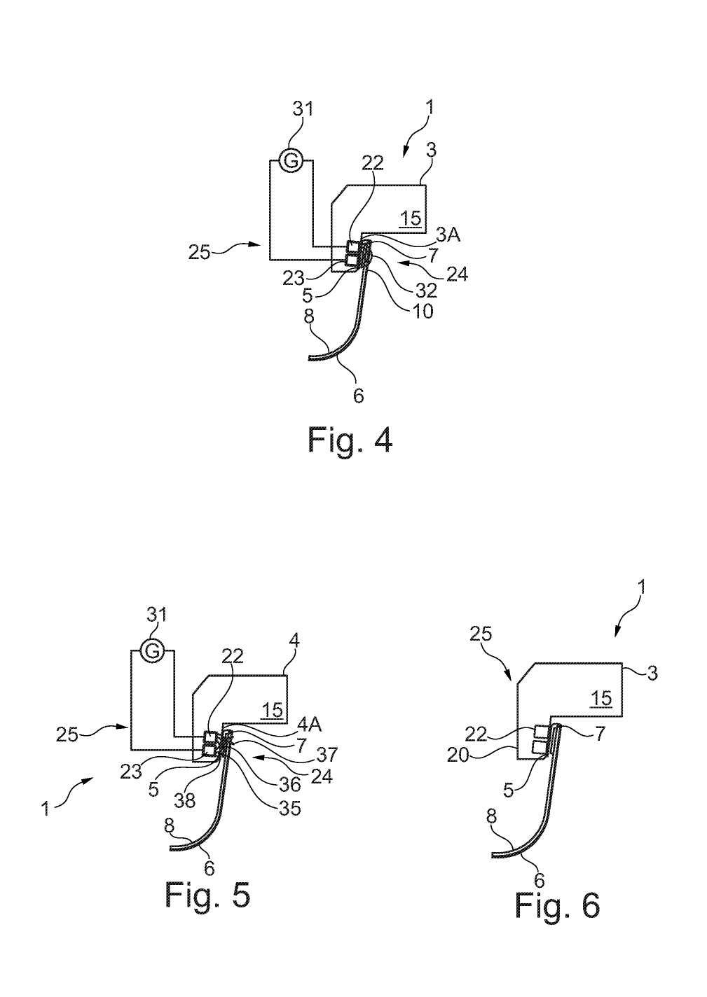

If the induction source 22 is now switched on by a suitable switch unit (not shown), preferably provided at the folding device 2, via the induction source 22 and thus also via the folding slide 3 electromagnetic alternating fields 24 can be generated (see FIGS. 4 and 5), by which in turn the fixing means 9 can be heated, as explained in the following with regards to FIGS. 4 and 5.

To this regards, with the folding slide 3 and particularly with the induction source 22 arranged therein a structurally particularly compact heating device 25 is realized at the folding device 2, which is integrated almost entirely in the folding slide 3.

According to the illustration of FIG. 1, the decorative layer 6 and the carrier part 8 are already overlapping and the border 5 of the decorative layer 6 to be folded over slightly projects beyond the edge 7 of the carrier part 8. The folding slide 3 is here still in an initial position 26.

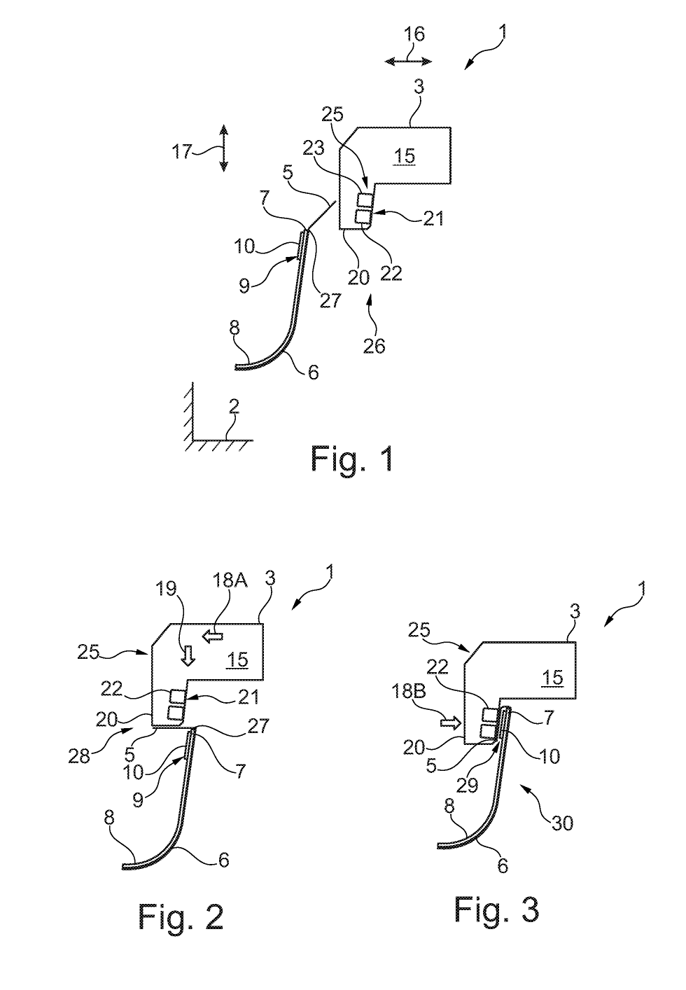

According to the illustration according to FIG. 2, the folding slide 3 according to the first direction of motion 16 has already been moved towards the left in the horizontal direction 18A, so that the folding slide 3 with its folding nose 20 has already brought the border 5 along a bending line 27 into a horizontal position 28.

In order to now further fold the border 5 downwards, the folding slide 3 moves approximately simultaneously or subsequently downwards according to a second direction of motion 17 in the vertical direction 19 and folds the border 5 further downwards so that the decorative layer 6 encompasses the edge 7 of the carrier part 8 in a U-shaped fashion.

According to the illustration according to FIG. 3 the folding slide 3 is returned in the sense of the horizontal direction 18B in order to press the folded border 5 against the carrier part 8, forming a gap and/or a glue joint 29.

The edge 7 [sic] of the decorative layer 6 is therefore now in the folded state 30.

Here, the fixing means 9 are now placed inside this glue joint 29 between the border 5 and the edge 7.

As already explained above, the fixing means 9 used represent a thermally activated adhesive 10, which now only needs to be activated by the electromagnetic alternating fields 24.

According to the illustration of FIG. 4, for this purpose the induction source 22 is switched on, with it being fed by an electric current (not explicitly marked), which induction source in turn being initiated with the help of a generator 31 at the folding device 2.

In the variant A shown in FIG. 4 the fixing means 9 directly represent an induction receiver 32, because ferromagnetic particles (not shown) are substituted in the adhesive 10 used, by which the electromagnetic alternating fields 24 of the induction source 22 can immediately interact, causing eddies (not shown) to form in the induction receiver 32, which in turn are converted into thermal energy inside the adhesive 10.

To this regards, the adhesive 10 in the sense of the disclosure can be seen as an induction receiver 32 and the adhesive 10 is directly heated by the switched-on induction source 22.

The variant B shown in FIG. 5 shows a slightly different situation, in which a ferromagnetic plate element 35 serves as an alternative induction receiver 36, which can directly interact with the electromagnetic alternating fields 24 of the induction source 22, causing eddies to form in the alternating induction receiver 36 which are converted into thermal energy.

Here, both the induction source 22 as well as the alternating induction receiver 36 are arranged at the folding slide 4.

The compression plate 21 is here essentially formed by the ferromagnetic plate element 35 and/or the alternative induction receiver 36.

The ferromagnetic plate element 35 therefore heats up by the interaction with the electromagnetic alternating fields 24, and since is simultaneously forms a decorative layer—contact area 37, an alternative adhesive 38 is indirectly heated thereby via the decorative layer 6.

To this regards, in the variant B the alternative adhesive 38 is only indirectly heated by the induction source 22 and/or its electromagnetic alternating fields 24.

It is understood that in the variant B the adhesive 10 can also be used as an additional induction receiver 32, when this seems beneficial for example with regards to a customer-specific application.

Otherwise, the design of the folding slides 3 and 4 is essentially identical so that with regards to the other features concerning the folding slide 4 reference is made to the description of the folding slide 3 in order to avoid repetitions.

In particular, the induction source 22 is arranged respectively at a side 3A and/or 4A of the folding slide 3 and/or 4 facing the decorative layer 6 and/or the carrier part 8 such that the electromagnetic alternating fields 24 not necessarily need to be embodied unnecessarily strong. This also allows to operate the heating device 25 and/or the induction source 22 in an energy saving fashion.

In order to allow a rapid cooling of the adhesion site (not explicitly marked) after the thermal treatment here a cooling fluid (not shown) flows through both the folding slide 3 as well as the folding slide 4.

For this purpose the folding slide 3 and/or 4 are penetrated by respective cooling channels (not shown), with cumulatively or alternatively the induction source 22 may also show such cooling channels (not shown either).

In a very simple case the cooling fluid may comprise water.

According to the illustration seen in FIG. 6 the folding slide 3 shown there is in such a respective cooling phase.

It shall be understood that the above-explained exemplary embodiments only represent first embodiments of the folding slide device according to the disclosure. To this regard, the embodiment of the disclosure overall is not limited to these exemplary embodiments.

All of the features disclosed in the document are claimed to be essential for the disclosure, to the extent they are novel in reference to prior art, individually or in combinations.

1. A method for folding a border of a decorative layer about an edge of a carrier part, in which the border is folded via a folding slide at least partially about said edge, and in which a fixing means in the form of an activated adhesive is used to fix the border of the decorative layer in the folded state at the carrier part, wherein an induction source is used to activate the adhesive, which generates electromagnetic alternating fields causing eddies to form in an induction receiver which are converted into thermal energy.

2. A method according to claim 1, wherein the electromagnetic alternating field is generated via a folding slide.

3. A method according to claim 1, wherein the adhesive that can be activated is heated inductively by induction receivers included in the adhesive being heated by the electromagnetic alternating fields emitted by the induction source.

4. A method according to claim 1, wherein an adhesive is used embodied as an induction receiver, primarily showing ferromagnetic particles.

5. A method according to claim 1, wherein the folding slide inductively heats at least partially a decorative layer contact area particularly embodied as an induction receiver of the folding slide via a plurality of electromagnetic alternating fields emitted by the induction source, and previously, during, and/or thereafter at least partially it is made to contact the decorative layer with the border to be heated.

6. A method according to claim 1, wherein a cooling fluid flows through the folding slide.

7. A folding slide device for folding a border of a decorative layer about an edge of a carrier part with a spatially displaceable folding slide and with a heating device for heating the edge of the carrier part, the border of the decorative layer, or an adhesive arranged at the edge and/or the border for performing the method according to claim 1, wherein the folding slide includes an induction source for generating an electromagnetic alternating field.

8. A folding slide device according to claim 7, wherein the induction source is arranged at a side facing the decorative layer of the folding slide.

9. A folding slide device according to claim 7, wherein on the first folding slide a decorative layer—contact area that can be inductively manipulated is embodied as an induction receiver.

10. A folding slide device according to claim 7, wherein the induction source is cooled by liquids.

11. A folding slide device according to claim 7, wherein the induction source includes at least two or three degrees of freedom.

12. A folding slide device for folding a border of a decorative layer about an edge of a carrier part, whereby an electromechanically driven folding slide is foreseen and the folding device is implemented in order to use a fixing means in the form of an adhesive for the purpose of fixing the edge of the decorative layer in a glue joint in the folded state, wherein the folding device includes an electromagnetic induction source and is implemented to switch on and off the induction source for the direct or indirect heating and activating of the adhesive.

13. The use of an induction receiver of an adhesive arranged at a decorative layer for coating a carrier part and/or a decorative layer to be carried at a carrier part for heating said adhesive.

14. The use of an induction receiver arranged at a decorative layer for coating a carrier part and/or a carrier part for carrying a decorative layer and/or an induction receiver arranged at a folding slide for heating an adhesive for adhering a border of the decorative layer to an edge of the carrier part.
